(19) United States
(12) Patent Application Publication
(10) Pub. No.: US 2009/0160195 A1
(43) Pub. Date: Jun. 25, 2009

(54) Wind-catcher and accelerator for generating electricity

(76) Inventor: Michael Klim Culjak, Okeechobee, FL (US)

Correspondence Address: Michael Klim Culjak, 19170 NW 80th Drive, Okeechobee, FL, 34972, US

(21) Appl. No.: 12/283,776

(22) Filed: Sep. 16, 2008

Related U.S. Application Data
(60) Provisional application No. 60/978,285, filed on Oct. 8, 2007.

(51) Int. Cl. F03D 9/00

(52) U.S. Cl. 290/55

(57) ABSTRACT

This invention relates to an apparatus for capturing and accelerating the flow of a fluid in a moving stream so as to efficiently produce electricity through the use of a turbine or similar device connected to an electrical generator.

### BACKGROUND OF THE INVENTION

1. Field of Invention

The current invention relates to the generation of electricity with wind power, and more specifically to the efficient capture and acceleration of wind with a windmill device.

2. Prior Art

A funnel wind generator includes a vertically located turbine (1) and is associated with a roof of a building wherein the actual roof can be constituted by the lower surface of the funnel of the invention. The roof structure of the building is replaced by the vertical dividers, as known from WO9904163A1.

An apparatus for improving the generation of wind-powered energy is configured to be placed in front of a windmill. The apparatus has an entry aperture spaced from the windmill blades and having an entry aperture dimension that is greater than the tip-to-tip span of the rotatable windmill blades. The apparatus further includes an exit aperture that is located adjacent the windmill blades and dimensioned substantially equal to the tip-to-tip span of the rotatable blades. Further, a funnel material is spanned between the entry and exit apertures and is adapted to guide wind received within the entry aperture toward the exit aperture and thence to the rotatable blades of the windmill so that a speed of the wind is increased as the wind passes from the entry aperture to the windmill blades, as known from US20070001465A1.

A wind-powered machine for producing energy includes a support frame, a rotor having a plurality of vanes, the rotor having a wind gathering face side and an opposed rear side, and an infeed funnel for channeling wind to the face side of the rotor and increasing the speed of the wind. A rear wind deflector captures wind passing over the rotor and deflects it downwardly to vanes on the rear side of the rotor. A turntable mounts the rotor, infeed funnel, and rear wind deflector to permit such to be directed properly into the wind. A generator connected to the rotor produces electrical energy which is transmitted through a rotational connection to electrical storage medium, as known from U.S. Pat. No. 6,239,507.

A system for collecting and channeling wind energy includes funnel-shaped wind collectors rotatably attached to elevated platforms for collecting wind streams at higher initial velocities. A fantail assembly rotates the inlet end of the funnel into the face of the wind. The funnel is slidably connected to a railing atop the platform to maintain the inlet of the funnel at a desired relationship with the wind stream as well as to preclude separation of the funnel from the platform. Wind entering the inlet of the funnel-shaped collector flows toward a reduced outlet end of the collector resulting in an increased velocity. The collected air is channeled through a tubular branch conduit and merged into a transmission conduit of equal diameter for delivery to a transmission assembly. The transmission assembly includes a nose rotor which compresses and directs air away from the central axis of rotation of a downstream propeller and onto the propeller blades at increased velocity for rotation of an attached drive shaft. Upon use of a plurality of wind collectors, the respective branch conduits are merged into the transmission conduit at spaced intervals there along so as to increase the velocity of the air stream delivered to the transmission conduit and downstream transmission assembly, as known from U.S. Pat. No. 5,977,649.

An accelerator for a windmill structure as described which is a frustro-conical funnel-like device intended to direct a stream of wind therethrough onto the impeller of a windmill. As the wind passes through the device, it is constricted whereby the velocity increases and exits a throat-like outlet as a diverging jet impacting the impeller blades to thereby increase the kinetic energy available to be converted to mechanical or electrical energy by said windmill. The device of this invention can include a vane for maintaining the accelerator facing into the wind with the windmill, a mounting platform for either the accelerator or both accelerator and the windmill, and an internal configuration to said accelerator to impart a swirling spiral motion to the wind passing therethrough as it is constricted, as known from U.S. Pat. No. 5,457,346.

A wind-driven apparatus for the conversion of kenetic energy in the form of wind to rotational mechanical energy. This apparatus incorporates a funnel that directs wind against a collector causing it to rotate. To prevent any backpressure in the funnel or against the collector, the area immediately downstream of the collector is free of any obstacle or channeling devices. To also prevent any backpressure from developing, a series of blow-through panels form a part of the funnel which open upon the presence of high pressure—the greater the pressure, the greater the opening, as known from U.S. Pat. No. 5,009,569.

An apparatus and method of harnessing combined wind and wave energy for generating, e.g., electrical power which includes a first housing held at a fixed height above the bottom of a body of water and having an internal cavity, and a buoyant second housing having an internal cavity surrounded by sleeves into which the walls of the internal cavity of the first housing are slidably contained for allowing relative movement between the first and second housings in response to wave action, with the first body containing a plurality of funnel-like openings for receiving air driven by the wind and directing it through at least one set of turbine blades, and also with the internal cavity of the second housing having a flapper valve which is normally open to the fluid communication between the internal cavities when the wave action moves the second housing upwardly from the first housing, and which closes in response to the downward movement of the second housing with respect to the first housing as the wave passes by, thereby pumping air trapped in the internal cavity across the blade of a second set of turbines, with the discharge of this second set of turbines supplying air to assist in turning the first set of turbines, as known from U.S. Pat. No. 4,266,403.

Wind wheel electric power generator apparatus is disclosed as including a housing rotatably mounted upon a vertically disposed support column. Primary and auxiliary funnel-type, venturi ducts are fixedly mounted upon the housing for capturing wind currents and for conducting the same to a bladed wheel adapted to be operatively connected with generator apparatus. Additional air flows are also conducted onto the bladed wheel, all of the air flows positively effecting rotation of the wheel in a cumulative manner. The auxiliary ducts are disposed at an acute angle with respect to the longitudinal axis of the housing, and this feature, together with the rotatability of the housing and the ducts, permits capture of wind currents within a variable directional range, as known from U.S. Pat. No. 4,191,505.

An impeller having an axle with radial vanes is mounted within a housing. The housing includes a funnel to direct a large amount of wind into the impeller. Air fins on top of the housing maintain the funnel pointed into the wind. A flap upon the top of the housing will fold downward as the wind increases and this will raise a throttle valve at the throat of the funnel. In addition, the flap will close exhaust openings from the housing, also reducing the wind on the vanes. Two additional flaps act as pressure relief valves in the funnel which open to dump wind at excessive velocity. Furthermore, a leeward flap on the side of the funnel is blown out to an extended position at high winds which causes the housing to rotate upon its circular tracks to bring the funnel opening away from the wind. The air fins on top of the housing are blown down from the vertical position as the wind strikes the housing sideways. The housing is mounted upon a frame which extends horizontally outward from the housing. The frame is mounted by wheels upon concentric rails. Therefore, the housing can be maintained directly into moderate winds by rotating around upon the rails or high winds will cause the housing to rotate away from the wind. The large frame prevents the unit from blowing over, as known from U.S. Pat. No. 4,127,356.

Wind motors which are propelled by the impact of the wind against the vanes of an impeller wheel, that have wind channeling devices that gather the wind from a large area and funnel it at increased density and pressure to apply multiplied impact against the impeller vanes, as known from U.S. Pat. No. 3,988,072.

Wind motors which are propelled by the impact of the wind against the vanes of an impeller wheel, that have wind channeling devices that gather the wind from a large area and funnel it at increased density and pressure to apply multiplied impact against the impeller vanes, as known from U.S. Pat. No. 3,986,786.

Wind motors which are propelled by the impact of the wind against the vanes of an impeller wheel, that have wind channeling devices that gather the wind from a large area and funnel it at increased density and pressure to apply multiplied impact against the impeller vanes, as known from EPO894977A1.

The disclosure relates to a funnel wind generator comprising at least one vertically located turbine (1) and having thereabout a plurality of outwardly extending wings (10) which direct the flow of wind to the turbine to cause efficient operation thereof. The wings are tangential to the periphery of the turbine and are equidistantly spaced around the periphery of the turbine to provide a series of adjacent funnels (14) through which wind can pass to the turbine. The wings can be supported by spaced discs (13) encircling the turbine, as known from EP0867615A1A.

### SUMMARY OF THE INVENTION

1. An apparatus for capturing and accelerating the flow of a fluid in a moving stream so as to efficiently produce electricity through the use of a turbine or similar device connected to an electrical generator comprising

a. A funnel-shaped contractor (2) with a preferred diameter opening of 28 feet, which captures the entire force of the wind and accelerates it by a factor of seven or more as it feeds into a smaller section 4 feet in diameter (3) inside of which there is a screw turbine (4) or similar device to convert the increased energy to electricity by means of a gearbox (9) which connects to a generator (10)

b. This apparatus is contained in an aerodynamically streamlined housing (FIG. 2) which serves a dual purpose; that of permitting the entire device to weather-cock automatically and to allow the apparatus to blend in with the landscape as much as possible.

### BRIEF DESCRIPTION OF THE DRAWINGS

FIG. 1 is a side view of an embodiment of the device mounted on a mast.

FIG. 2 is also a side view of the device in FIG. 1 contained in a streamlined housing and mounted on a mast.

### DETAILED DESCRIPTION OF THE DRAWINGS

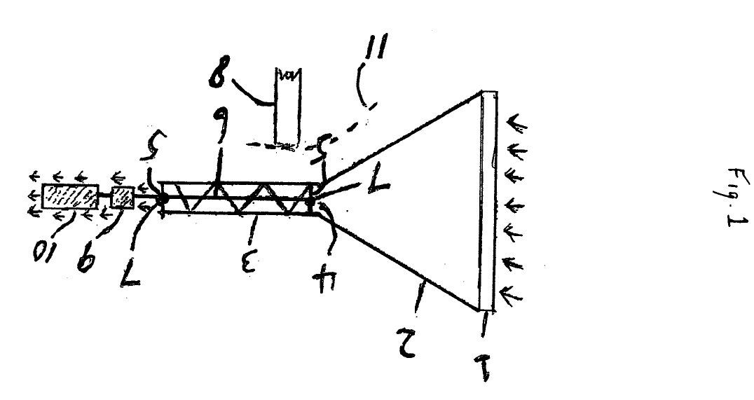

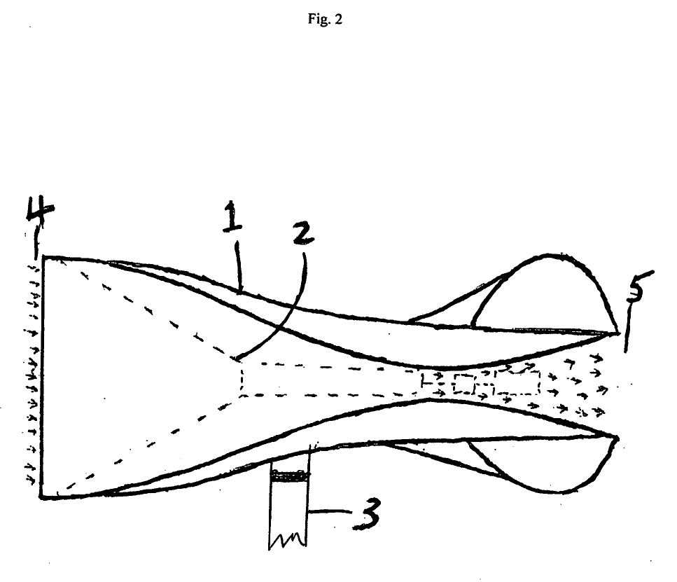

FIG. 1 is a side view of an embodiment of the device mounted on a mast. The elements include:
1. A flange to enhance the wind gathering capability of the wind contractor
2. The wind contractor which feeds into the screw turbine tube
3. The screw turbine tube revealing the mechanism inside
4. The screw turbine
5. Faired braces supporting the turbine shaft
6. The turbine shaft
7. The shaft bearings
8. The support mast for the device
9. A gearbox
10. A generator
11. Approximate edge of the device housing shown in FIG. 2

FIG. 2 is a side view of the device of FIG. 1 encased in its housing.

The elements include:
1. The streamlined housing
2. Outline of the device inside the housing
3. Mast supporting the device and its housing
4. Entrance for the fluid
5. Exit of the fluid

What I claim is:

1. A power generating apparatus comprising: a funnel-shaped contractor which captures the ambient wind and significantly increases its velocity over what it was when entering the funnel, the higher velocity air then being fed into a tube containing a high speed screw turbine, the turbine's shaft being connected to a gear reduction box which connects to a generator at reduced rpm and proper torque.

2. A power generating apparatus with a large opening in front which captures the ambient wind and processes it as in claim 1 above and then expels the air at the other end.

3. A power generating apparatus which is capable of maintaining proper orientation to the wind.

4. A power generating apparatus which is greatly more efficient than the conventional three bladed wind turbine in general use for producing electricity, whereas the wind turbine uses only a small portion of the wind's energy in the sweep of its blades this invention captures almost all of the wind's energy with a wind contractor of an equal diameter as the sweep of the wind turbine's blades.

5. A power generating apparatus which can produce electricity at lower wind velocities because it not only uses the real power of the wind but also multiplies it.

6. A power generating apparatus which is relatively inexpensive to build and maintain since the design is simple and much of the parts are “off the shelf”.

7. A power generating apparatus which can gain quick acceptance by the public since its streamlined design would be less of an eye-sore, can be much smaller than the three-bladed wind turbine to produce an equal amount of power, and the noise factor, a concern with the three-bladed wind turbine, would be small.

8. A power generating apparatus which would have much less of an impact on wild life such as birds and bats.
